(19) United States
(12) Patent Application Publication
(10) Pub. No.: US 2021/0122502 A1
(43) Pub. Date: Apr. 29, 2021

(54) Launch and Flight Configurations for Transfer Space Vehicles

(71) Applicant: MOMENTUS INC., Santa Clara, CA (US)

(72) Inventors: Mikhail Kokorich, Santa Clara, CA (US); Aaron Mitchell, Santa Clara, CA (US)

(21) Appl. No.: 16/687,614

(22) Filed: Nov. 18, 2019

Related U.S. Application Data
(60) Provisional application No. 62/926,413, filed on Oct. 25, 2019.

(51) Int. Cl. B64G 1/64; B64G 1/40; B64G 1/10; B64G 1/00

(52) U.S. Cl. CPC B64G 1/645; B64G 1/402; B64G 2001/643; B64G 1/007; B64G 1/1085

(57) ABSTRACT

A system for delivery to space on a launch vehicle includes a first payload configured to directly couple to an adapter structure of the launch vehicle, a second payload configured to directly couple to the adapter structure of the launch vehicle, and a tether between the first payload and the second payload. Subsequently to separation from the launch vehicle, the first payload is configured to move relative to the second payload, using the tether, to dock with the second payload.

### CROSS-REFERENCE TO RELATED APPLICATION

The present application is a non-provisional application claiming priority to U.S. Provisional Patent Application No. 62/926,413, filed Oct. 25, 2019, the disclosure of which is incorporated herein by reference in its entirety for all purposes.

### FIELD OF THE DISCLOSURE

The present disclosure generally relates to delivering payloads to designated orbits in space and, more particularly, to configuring payloads within a launch vehicle.

### BACKGROUND

A launch vehicle (or simply “launch vehicle”) can deliver a primary payload as well as additional, secondary payloads (e.g., smaller satellites) to one or more orbits. There are several techniques a launch vehicle can use to support the secondary payloads. For example, a launch vehicle can be equipped with a standardized payload adapter structure such as an Evolved Expendable Launch Vehicle (EELV) Secondary Payload Adapter (ESPA) or the version known as ESPA Grande. An ESPA is a ring with multiple (e.g., four, six) round ports of a certain diameter (e.g., 8 inches, 15 inches, 24 inches). Payloads are attached to the ESPA on the ground via respective ports, and the launch vehicle releases the payloads upon reaching the orbit(s). According to another technique (used with the Russia's Soyuz rocket for example), a custom-built structure includes multiple “shelves” used to attach secondary payloads via payload adapters. Yet another technique involves attaching secondary satellites to a flat surface on top of the primary payload.

Today, when the payloads of the launch vehicle include an orbital transfer vehicle (or simply “transfer vehicle”) that delivers its own one or more payloads to certain orbits, the payload is mounted on (docked to) the transfer vehicle, and the transfer vehicle is mounted on the launch vehicle vertically or using an ESPA. For example, a Fregat vehicle mounts on top of a Soyuz launch vehicle, and the payload attaches to the Fregat vehicle. The orbital transfer vehicles developed more recently for small payloads, such as small satellites, use EPSA or ESPA Grande adapters to receive payloads. These configurations create stringent requirements for the strength of the structure binding the payload of the transfer vehicle to the transfer vehicle. Moreover, this configuration increases the difficulty of conforming the transfer vehicle with the payload(s) to the volume envelope and/or the mass envelope, which is limited for most launch interfaces.

### SUMMARY

The techniques of this disclosure improve the efficiency of the interface between a launch vehicle, a transfer vehicle, one or more additional propellant tanks of the transfer vehicle in some cases, and one or more payloads of the transfer vehicle. In particular, some of these techniques reduce the amount of force applied to the payload adapter structure at any single point as well as the volume envelope, relative to the existing techniques, while allowing the same total weight to be coupled to the launch vehicle for delivery to space. Additionally, the techniques relax the requirements on the volume and mass envelopes of transfer vehicles and their payloads, as well as on docking interfaces between transfer vehicles and payloads. These techniques also standardize volume and mass envelopes for the transfer vehicle payload by making these envelopes the same as the standard launch vehicle payload envelopes.

To this end, the transfer vehicle connects with one or more payloads of the transfer vehicle using a tether mechanism, and the one payloads of the transfer vehicle removably couple directly to the launch vehicle payload adapter structure. After separation from the launch vehicle, the transfer vehicle can use the tether mechanism as a connector to the payload(s), or to modify the orientation of the payload(s) relative to the transfer vehicle and, when needed, to dock with the payload(s) using docking devices and mechanisms. In a similar manner, the transfer vehicle can use the tether mechanism with additional propellant tanks or with a second transfer vehicle payload, if needed.

Some of the techniques of this disclosure more efficiently utilize the hollow cavity defined by an annular or other hollow-shaped payload adapter structure. The cavity in these implementations can permanently or temporarily enclose a tank with a propellant for use by the transfer vehicle (or another space vehicle). Shortly before separating from the launch vehicle, the transfer vehicle can extract the propellant from the tank within the annular payload adapter structure, or extract the entire tank when the tank is elastic or collapsible.

Further, some of these techniques improve volume utilization of the payload bay by interconnecting payloads along one or more guides (or rails) within the payload adapter structure. The one or more guides also allow the weight of the payloads to be distributed more evenly within the payload bay, thereby eliminating the need to use “dummy” weights for load balancing. The one or more guides in various implementations can include a single rail, parallel rails, a cable, etc. Multiple guides can extend radially within a cylinder structure of the payload adapter structure, at a single “floor” or multiple floors. As another example, a guide can have a helical or spiral structure, or multiple parallel guides can be disposed at multiple floors within the payload adapter structure. The guiding mechanism or payload adapter can drive the payload(s) forward or backward during the balancing process and/or during deployment in space. Further, the guiding mechanism can be configured to stop and hold in place the payload during launch vehicle integration and launch. The payloads can depart from the launch vehicle as a train in which the payloads on a shared guide are tethered to each other. When one of the payloads in the “train” is a transfer vehicle, the transfer vehicle after deployment can push or pull the payload(s) deployed on the shared guide.

One example embodiment of these techniques is a system for deliver to space on a launch vehicle. The system includes a first payload configured to directly attach to an adapter structure of the launch vehicle, a second payload configured to directly attach to the adapter structure of the launch vehicle, and a tether between the first payload and the second payload. Subsequently to separation from the launch vehicle, the first payload is configured to move relative to the second payload, using the tether, to dock with the second payload.

Another example embodiment of these techniques is a system including a launch vehicle configured to deliver one or more payloads to space. The launch vehicle has an adapter structure that includes one or more walls enclosing a cavity, and at least one port in the one or more walls. The system further includes a payload configured to couple to the launch vehicle via the at least one port of the adapter structure, and a tank disposed within the cavity and configured to store a propellant for use by the payload.

Yet another example embodiment of these techniques is an adapter structure for coupling at least one transfer vehicle to a launch vehicle that delivers the transfer vehicle to space. The adapter structure includes one or more walls enclosing a cavity and at least one port to removably receive the transfer vehicle and release the transfer vehicle when the launch vehicle reaches an initial orbit. The adapter structure further includes a tank disposed inside the cavity and configured to store a propellant for use by the transfer vehicle.

Still another example embodiment of these techniques is a method for providing propellant in space. The method includes providing an adapter structure for removeably coupling a payload to a launch vehicle, where the payload detaches from the launch vehicle upon reaching an initial orbit, and where the adapter structure includes (i) at least one port in one or more walls enclosing a cavity, via which the payload removeably couples to the adapter structure, and (ii) a tank disposed inside the cavity. The method also includes providing a propellant inside the tank, causing the adapter structure to separate from the launch vehicle subsequently to the payload detaching from the launch vehicle, to enter a certain orbit, and providing access to the tank to a spacecraft that docks with the adapter structure at the certain orbit.

Another example embodiment of these techniques is a payload adapter structure of a launch vehicle configured to deliver payloads to space. The payload adapter structure includes a guide having an elongated body and mounted within the payload adapter structure, where the guide is adapted to removeably receive and moveably retain a first payload and a second payload.

In another example embodiment, removable containers attach to the launch vehicle, with payloads disposed inside the containers. The containers can be shaped as parallelepipeds, cylinders, etc. The containers can mount on top of each other to allocate multiple layers to a payload. The containers in some implementations have divisible height, so that in different configurations different numbers of containers are vertically allocated on the same layer. Further, the containers can be expandable or reusable (when the launch vehicle is capable of returning the contains back to Earth). Depending on the implementation, the containers can include walls or only structural ribs with no walls. Still further, the containers can include guides such as rails, and guides in one container can connect to the guides in another container to provide an uninterrupted path for deployment of payloads into space.

### BRIEF DESCRIPTION OF THE DRAWINGS

FIG. 1 schematically illustrates separation of a transfer vehicle from a launch vehicle at a first orbit, and subsequent separation of a payload of the transfer vehicle from the transfer vehicle at a second orbit, where the launch vehicle, the transfer vehicle, and the payload can utilize the payload adapter structure of this disclosure;

FIG. 2A illustrates an example configuration in which both a transfer vehicle and a payload, to which the transfer vehicle is tethered, are directly coupled to a payload adapter structure;

FIG. 2B illustrates an example configuration in which two instances of the payload adapter structure are stacked to receive payloads;

FIG. 3A illustrates a configuration of a payload adapter structure in which payloads are removably coupled to guides on multiple levels of a payload bay;

FIG. 3B illustrates a modular configuration of a payload adapter structure in which payloads are removably housed in containers;

FIG. 4 illustrates a payload adapter structure enclosing a propellant tank;

FIGS. 5A-D illustrate the process of transferring propellant from a propellant tank enclosed within a payload adapter structure to an expandable tank of a transfer vehicle;

FIGS. 6A-C illustrate the process of transferring propellant from a propellant tank enclosed within a payload adapter structure to an expandable tank of a transfer vehicle, according to another implementation;

FIGS. 7A-C illustrate the process of transferring a propellant tank from within a payload adapter structure to a transfer vehicle;

FIG. 8A illustrates a tethering configuration including a swivel hinge mechanism, for interconnecting payloads coupled to a payload adapter structure;

FIG. 8B illustrates a tethering configuration including flexible cables, for interconnecting payloads coupled to a payload adapter structure;

FIG. 8C illustrates another tethering configuration including flexible cables, for interconnecting payloads coupled to a payload adapter structure,

FIG. 9A illustrates several payloads subsequently to separating from a payload adapter structure but prior to docking;

FIG. 9B illustrates an example docking configuration of the payloads of FIG. 9A;

FIG. 10A illustrates an example parallel configuration of guides for directing payloads within a payload adapter structure;

FIG. 10B illustrates an example radial configuration of guides for directing payloads within a payload adapter structure;

FIG. 10C illustrates an example spiral or helical configuration of guides for directing payloads within a payload adapter structure;

FIGS. 11A-B schematically illustrate example distribution of mass within a payload adapter structure using the guides of this disclosure; and

FIGS. 12A-C illustrate an example payload deployment scenario, which can be implemented using the techniques of this disclosure.

### DETAILED DESCRIPTION

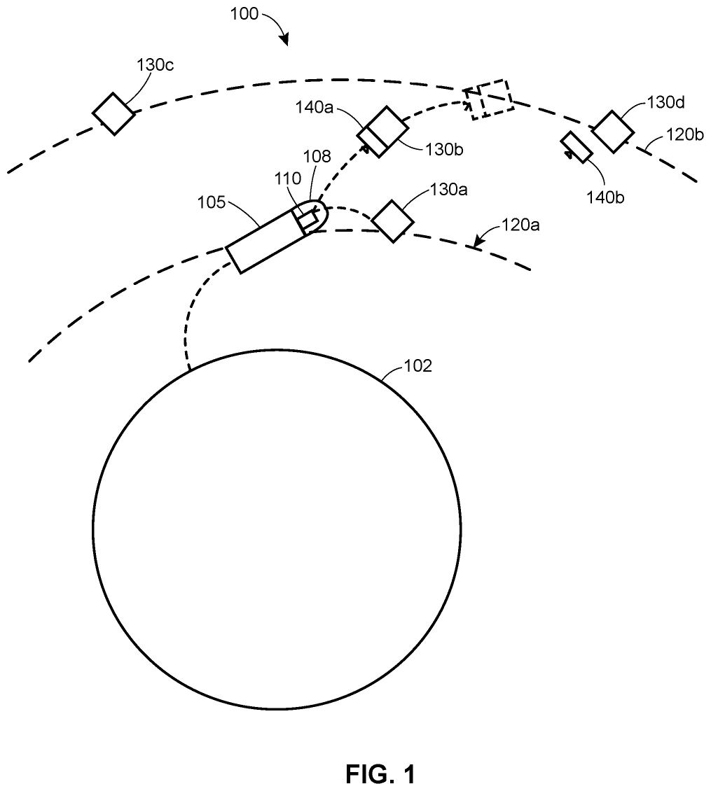

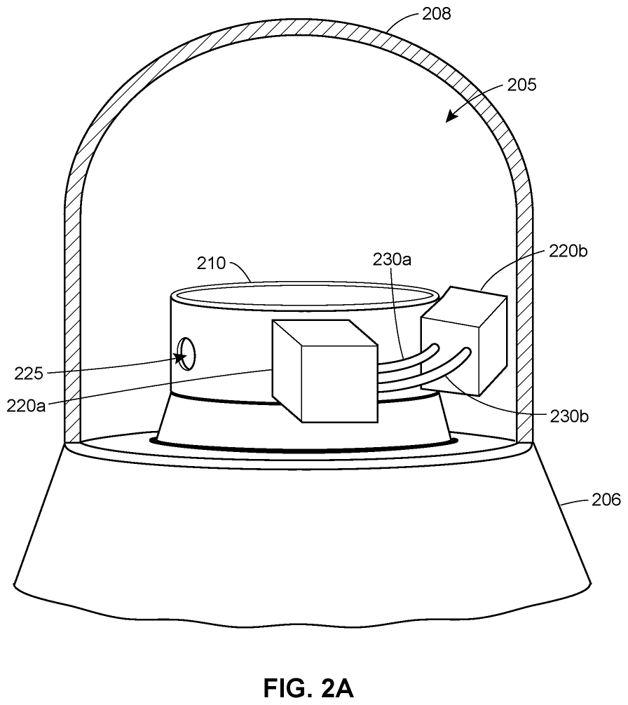

FIG. 1 illustrates an environment 100 within which a system for delivering payload from a planetary surface 102 to space on a launch vehicle 105 operates. The launch vehicle 105 includes a payload bay (best illustrated in FIGS. 2A and 2B) enclosed by a fairing 108 which houses a payload adapter structure 110. The payload adapter structure is configured to deploy one or more payloads in space by releasing the payloads at a first orbit 120a. The payloads may include satellites 130a-c, substantially confined to an orbit (first orbit 120a or second orbit 120b) upon release in space. Additionally or alternatively, the payloads may include space transfer vehicles 140a,b, capable of moving between two or more orbits. A transfer vehicle may be configured to deliver a satellite from one orbit to another.

In an example mission, the launch vehicle 105 may deliver the transfer vehicle 140a and the satellite 130b, both attached to the payload adapter structure 110, to the first orbit 120a. In some implementations, a coupled transfer vehicle and satellite combination (e.g., satellite 130b attached to the transfer vehicle 140a) may be configured as a single payload of the launch vehicle. To that end, the transfer vehicle may be configured to attach to a port (discussed below) on the payload adapter structure 110, while the satellite may be configured to attach to the transfer vehicle, without directly attaching to another port on the adapter structure. Conversely, the satellite may be configured to attach to a port on the adapter structure 110, while also attaching to the transfer vehicle that is not attached directly to a port. In another implementation, the transfer vehicle 140a may be configured to dock with the satellite 130b after being released from the payload adapter structure 110. Upon delivering the satellite 130b to the second orbit 120b, the transfer vehicle 140a may release the satellite 130b. For example, FIG. 1 illustrates the satellite 130d released by the transfer vehicle 140b at the second orbit 120b.

Docking the transfer vehicle 140a with the satellite 130b after deployment from the payload adapter structure 110, or at least after the launch vehicle reaches the first orbit 120a, may offer several advantages over launching a pre-docked assembly of the transfer vehicle 140a and the satellite 130b. On one hand, the transfer vehicle 140a and the satellite 130b, separately attached to the payload adapter assembly 110 may each utilize the full volume and/or mass envelopes allowed for payloads. On the other hand, the structural requirement of the docking mechanism may be considerably more relaxed than for a docking mechanism design to withstand the stress of launch.

FIG. 2A illustrates a payload bay 205 of a launch vehicle configured to transport the payload bay 205 to space. The payload bay 205 may be removably or fixedly attached to a rocket stage 206 of the space vehicle. In some implementations, the payload bay 205 may be removably or fixedly attached to another portion of the space vehicle, e.g. a cabin of the space vehicle (in manned flights), another payload bay, or any suitable portion of the space vehicle.

The payload bay 205 may be enclosed by a fairing 208, configured to reduce aerodynamic drag of the launch vehicle and protect the payload from mechanical and thermal stresses. The fairing in FIG. 2A is illustrated in a cut-through view, to simultaneously allow the visibility of the internal structure of the payload bay as described above. The fairing 208 may include two or more segments that fall away from the launch vehicle to deploy payload. In some implementation, the fairing may include a door through which payload may be released.

The payload bay 205 may include a payload adapter structure 210 configured to attach to one or more payloads 220a,b. The payload adapter structure may have an annular structure or shape with multiple ports (e.g. port 225) for attaching to the payloads 220a,b disposed, for example, along the circumference of the annular payload adapter structure 210. For example, the payload adapter structure 210 may be an evolved expendable launch vehicle (EELV) secondary payload adapter (ESPA).

The payload adapter structure 210 illustrated in FIG. 2A has four ports 225 (three are not visible), two of which are attached to the payloads 220a,b, while two remain unoccupied. The ports (e.g. port 225) of the payload adapter structure 210 may be configured to securely attach to the payloads 220a,b during launch and to release or deploy the payloads 220a,b in space at an appropriate time. As discussed above, one of the released payloads 220a,b may be a transfer vehicle (e.g., transfer vehicle 140a in FIG. 1) configured to dock with another payload that is a satellite (e.g., satellite 130b in FIG. 1), deliver the satellite to a different orbit, and subsequently undock from the delivered satellite.

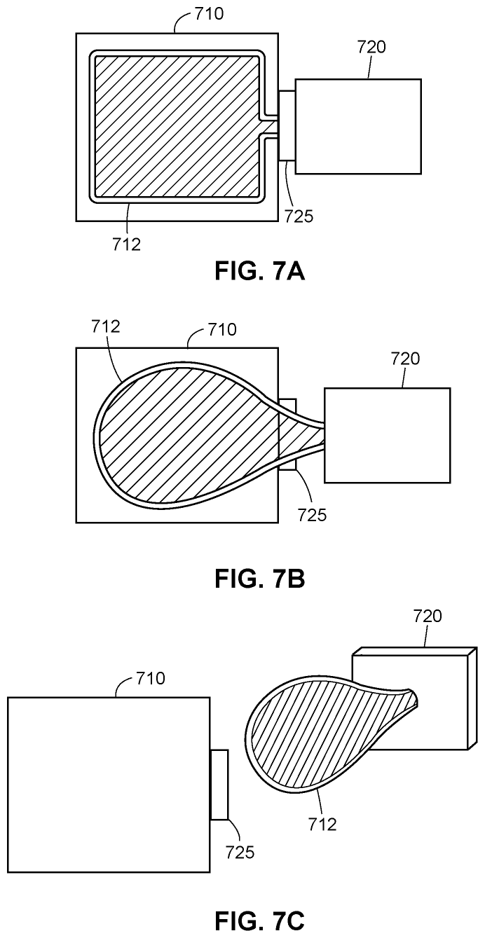

Once released, at least some of the payloads 220a,b may be configured for docking (connecting, coupling, etc.) with each other. To that end, each of the payloads 220a,b configured for docking may include a docking device (best illustrated in FIGS. 8A-C) configured to cooperate with a corresponding docking device on another payload to securely connect two payloads 220a,b together. The docking devices may include electromagnets or permanent magnets that may be configured to engage once two docking devices are in suitable proximity.

Two payloads 220a,b attached to the payload adapter structure 210 may be connected by one or more tethers 230a,b to facilitate bringing the two payloads 220a,b into suitable proximity with each other for docking after being released from the payload adapter structure 210. The tethers may be rigid connections (e.g., a swivel hinge mechanism) or a flexible connection (e.g., one or more cables). The docking of payloads 220a,b after their release from the payload adapter structure 210 is discussed in more detail below.

FIG. 2B illustrates the payload bay 205 with two annular payload adapter structures 210a,b stacked on top of one another, forming a combined payload adapter structure. The payloads 220c-g attached to the ports of the combined payload adapter structure may be connected in a variety of configurations. For, example payloads on the two stacked adapter structures 210a,b may be tethered along the axial direction of the launch vehicle (e.g., with a swivel hinge rigid tether 230b), while payloads on the same annular structure may be tethered along the azimuthal direction of the annular adapter structure (e.g., with flexible tethers 230e,f). In some implementations, payloads may be fluidicly connected with a pipe, a hose, or any other suitable fluid conduit 235. Such a fluidic connection may be configured for transferring a liquid propellant from one payload 220f to another payload 220g.

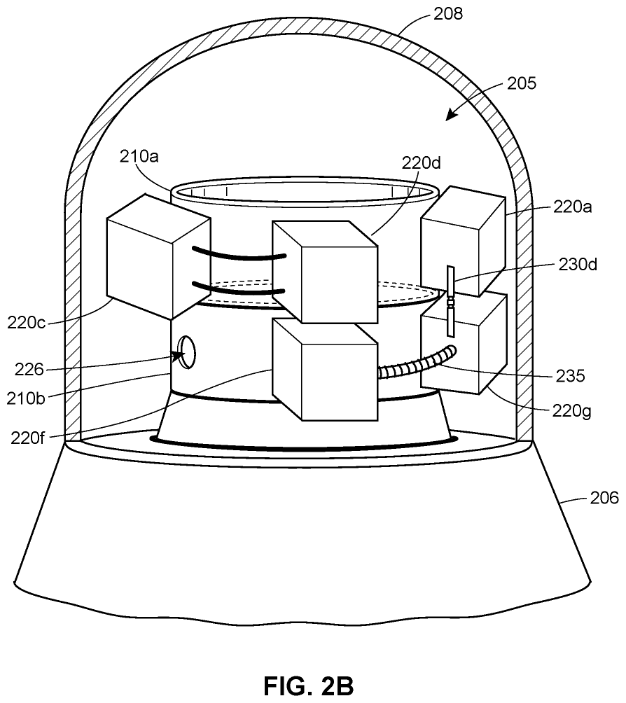

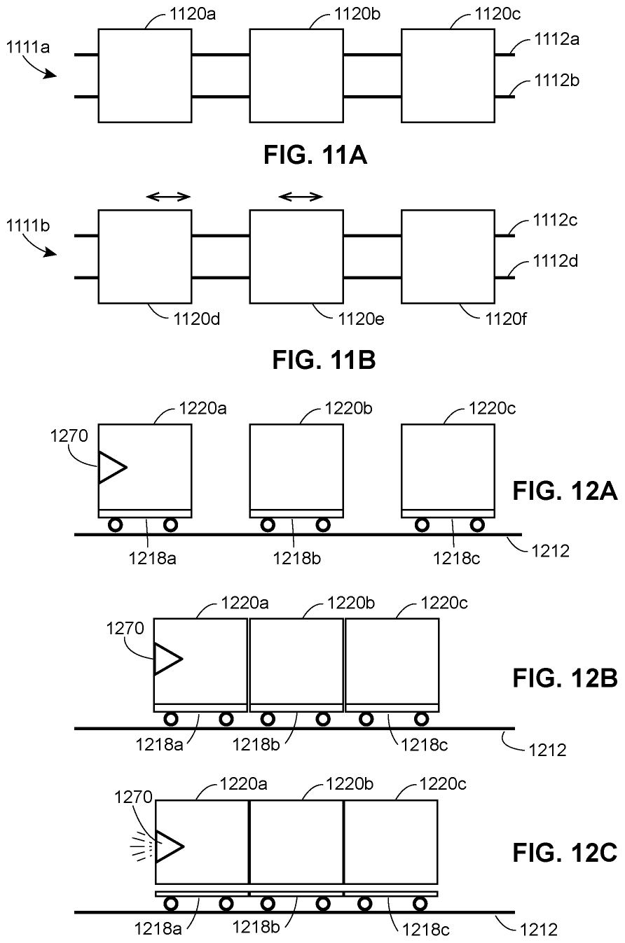

FIG. 3A illustrates another configuration of a payload adapter structure 310 in a payload bay 305 enclosed by a fairing 308 and attached to a rocket 306 of the launch vehicle. The payload adapter structure 310 may have multiple levels or shelves transverse to axial direction (i.e., acceleration direction) of the launch vehicle. Sets of guides 312a,b, 312c,d, 312e,f (e.g., rails) may be attached to each shelf of the payload adapter structure 310. In some implementations sets of guides 312a,b, 312c,d, 312e,f may be replaced by singular guides. In turn, payloads 320a-e may be configured to be removably attached to the guides 312a-f. In some implementations, the payloads 320a-e may be removably attached to carriers (best illustrated in FIG. 12) that in turn connect to the guides 312a-f. Whether directly, or by way of carriers, multiple payloads (e.g., payloads 320c,d) may connect to the same guide or set of guides (e.g., guides 312c,d) and may be configured to move along the direction determined by the guides. The payloads 320a-e or the carriers attached to the payloads may include breaking mechanisms to prevent motion along the guides 312a-f, for example, during a launch of the launch vehicle.

The guides 312c,d may be configured to facilitate sequential space deployment of payloads 320c,d, i.e. with the payload closer to the edge of the payload adapter structure 310 deploying into space before the payloads farther from the edge are deployed. In some implementations, as discussed below, payloads may deploy from the payload adapter structure 310 in parallel, releasing synchronously and/or independently of each other the connections to the guides or the carriers attached to the guides.

In some implementations, payloads 320a-e may move along the guides 312a-f before launch to balance the mass distribution of the total payload with respect to the axis of the launch vehicle. To that end, guides 312a-d on one shelf of the payload adapter structure 310 may run perpendicular to the guides 312e-f on another shelf. Other guide configurations are discussed below.

Additionally or alternatively, payloads 320a-e may move along the guides 312a-f to facilitate docking of payloads before being deployed from the payload adapter structure 310. Docking of one or more payloads using movement along guides may be used in lieu of or in combination with docking of tethered payloads after deployment. Payloads in the payload adapter structure 310 may be tethered either with flexible tethers (e.g., cable tether 330a) or rigid tethers (e.g., swivel hinge tether 330b).

FIG. 3B illustrates the payload bay 305 with a modular payload adapter structure 340 that includes containers 350a-g that, in turn, house payloads 320f-k. The containers 350a-g may be configured to mechanically attach to one another via one or more adaptors. At least some of the containers 350a-g may be deployable in space and, to that end, configured to detach from the payload adapter structure 340 at a suitable orbit. The containers 350a-g may be reusable in multiple launches.

Each container (e.g., of containers 350a-g) may house one or more payloads, securing the payloads during launch and deploying the payloads at a suitable orbit in space. In some implementations, multiple payloads in the same container (e.g., payloads 320i-k in container 350d) may be tethered together (e.g., with tether 330c) to facilitate docking after deployment, as discussed above.

Although rectangular prism containers are shown in FIG. 3B, the containers may have any suitable shape, including cylindrical, or, generally, prisms with any suitable polygonal base, for example. Containers of varying size may be configured to have dimensions of multiple attached containers match dimensions of one or more other containers to facilitate stacking. For example, the combined height of containers 350c, g matches the height of container 350e, while the width of container 350g matches the combined width of containers 350b,c.

Segments (e.g., segments 314a,b) of rails or guides may be attached to or built into containers (e.g., containers 350a,b), and configured to align to form longer rails or guides (e.g., rails 312g,h) when multiple containers (e.g., containers 350a,b), connect together. The containers with connected guides (e.g., containers 350a-c) may have openings in adjoining sides that allow payloads (e.g., payloads 320f-h) to traverse from one container into another before deploying into space.

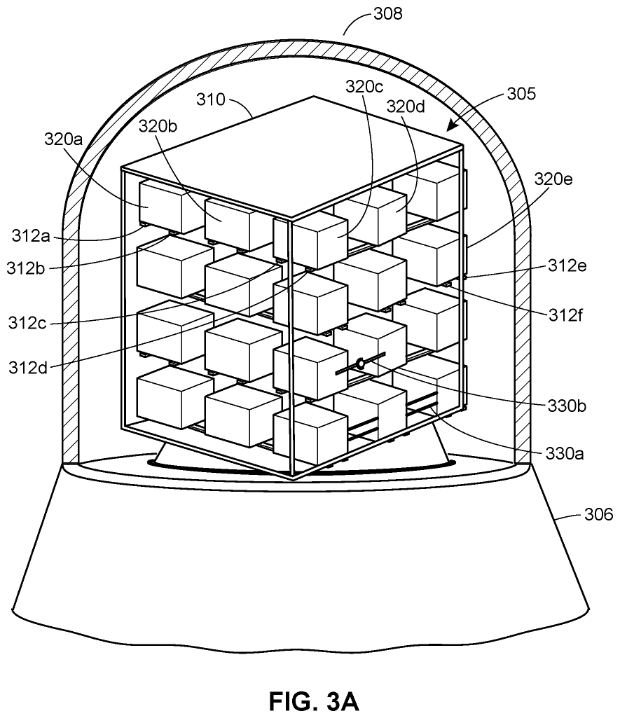

FIG. 4 illustrates a payload adapter structure 410 (e.g., the payload adapter structures 210 of FIGS. 2A and 2B) that is configured to store propellant 415 (e.g., water) within the cavity enclosed by the wall 412 of the payload adapter structure 410. In some implementations, the cavity of the payload adapter structure 410 may house a removable tank of propellant. In other implementations, the tank of propellant may be integrated into the payload adapter structure 410, with the wall 412 of the payload adapter structure also acting as the wall of the tank. One or more ports 425 of the payload adapter structure 410 may each include a fluid conduit 440 configured to fluidicly connect a payload 420 (shown in dashed lines) connected to the port 425. At least one of the ports (e.g., port 425) of the payload adapter structure may conform to ESPA format. The port 425, whether or not conforming to the ESPA format, may include the fluid conduit 440 configured to couple to the payload 420, for example via a push-on fitting and/or valve or another suitable connection. In some implementations, the fluidic connection between the tank within the cavity of the payload adapter structure 410 and the payload 420 may include a pump, as discussed below.

The tank within the cavity of the payload adapter structure 410 may be filled with propellant 415 before launch. In some implementations, the payload 420 may include an expandable propellant tank or a portion of the propellant tank may be expandable. Upon reaching the space environment and before deploying the payload 425, the fluidic connection between the tank and the payload may facilitate the transfer of propellant 415 from the tank in the payload adapter structure 410 to the payload 420, as described below. The tank in the payload adapter structure 410 may be a membrane tank or have an otherwise variable volume fluid compartment to substantially alleviate the vaporization of propellant 415 and the microgravity effects on the liquid content of the payload adapter structure tank.

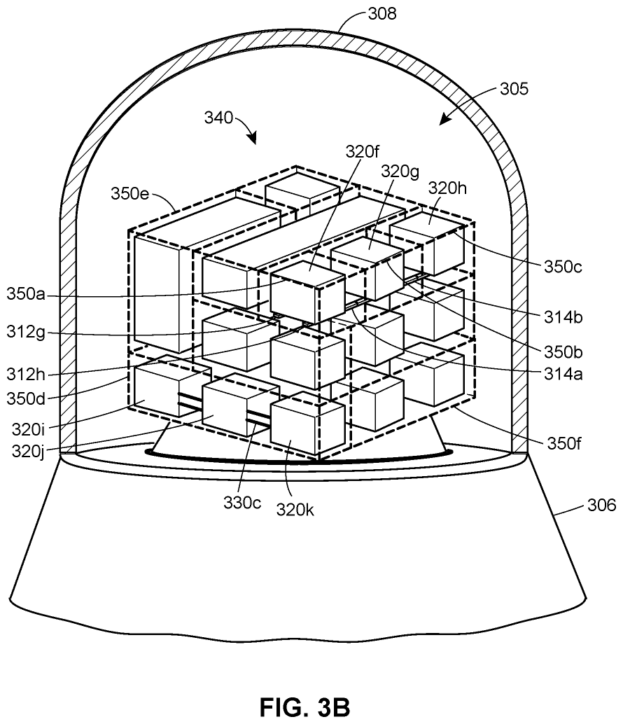

FIGS. 5A-D illustrate the process of filling an expandable tank 550 of a payload 520 (e.g., same as payload 420) with the propellant stored in the payload adapter structure 510 (that may be the payload adapter structure 410 of FIG. 4). Before the launch, a tank 512 within the cavity of the payload adapter structure 510 may be filled with propellant 515, while the expandable tank 550 on the payload 520 may be compressed, as shown in FIG. 5A. Compressing the expandable tank 550 of the payload 520 may maximize the volume efficiency (e.g., complying with a volume envelope) and improve structural integrity of the payload 520 (i.e., ability to withstand the acceleration and vibration during launch). Furthermore, keeping propellant 515 outside of the payload 520 before deployment may facilitate complying with the maximum mass requirement for payloads during launch.

Upon reaching the orbit of deployment for the payload 520 with the expandable tank 550, the payload deployment system may begin transferring the propellant 515 from the tank 512 within the payload adapter structure 510 to the expandable tank 550. FIG. 5B schematically illustrates the stage of the propellant transfer process when part of the propellant 515 is transferred to the expandable tank 550 of the payload 520. FIG. 5C illustrates the end stage of the propellant transfer process, with the tank 512 within the payload adapter structure 510 substantially empty, and the expandable tank 550 of the payload 520 substantially expanded. Upon transferring the propellant 515 from the tank 512 within the payload adapter structure 510 to the expandable tank 550, the payload adapter structure 510 may deploy the payload 520 by releasing it from the port (not shown, but analogous to port 425 in FIG. 4) as shown in FIG. 5D.

In some implementations, the payload adapter structure 510 may deploy payloads before transferring propellant 515 from the tank 512. The payload adapter structure may, for example, remain in orbit (e.g., orbit 120a of FIG. 1) to rendezvous with a space vehicle in need of propellant 515. To that end, the payload adapter structure 510 may include a docking device (best illustrated in FIGS. 8A-C), allowing to dock with a space vehicle, transfer the propellant 515, and undock with the space vehicle.

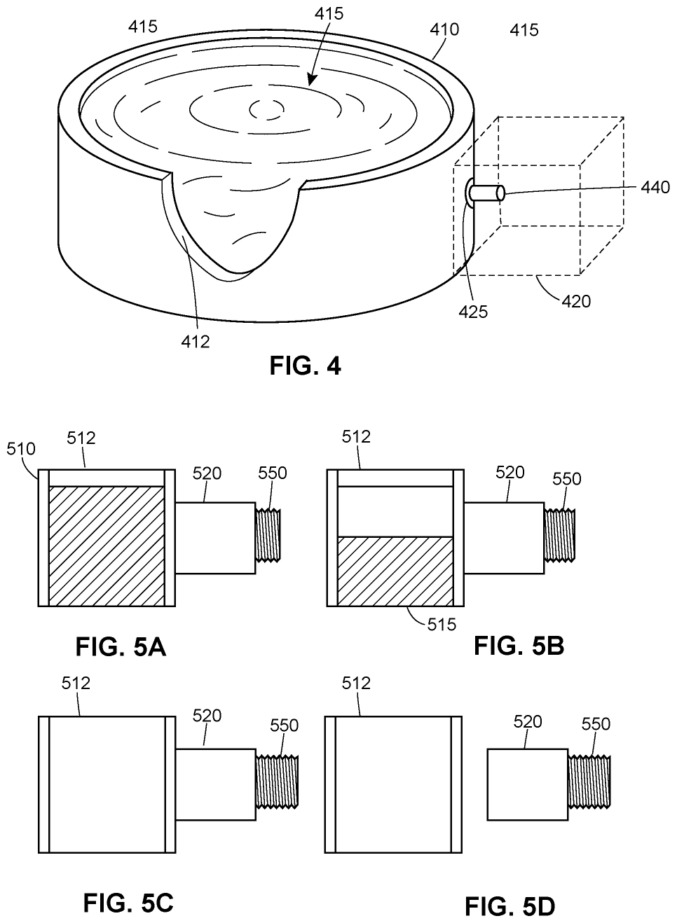

FIGS. 6A-C illustrate three configurations for transferring propellant 615a-c from the tanks 612a-c within the payload adapter structure 610 to the payloads 620a-c. In FIG. 6A, a pump 660a is disposed within the payload and/or is integrated into the structure of the payload 620a. In FIG. 6B, a pump 660 b is disposed (i.e., permanently mounted) within the cavity of the payload adapter structure 610b. In FIG. 6C, a piston 665 may squeeze the propellant 615c out of the tank within the payload adapter structure 610c into the tank 650c of the payload 620c. To that end, the payload adapter structure 610c may include an actuator configured to move the piston 665. The actuator may include a motor or may use compressed gas, for example, to move the piston 665 to squeeze the propellant out of the tank.

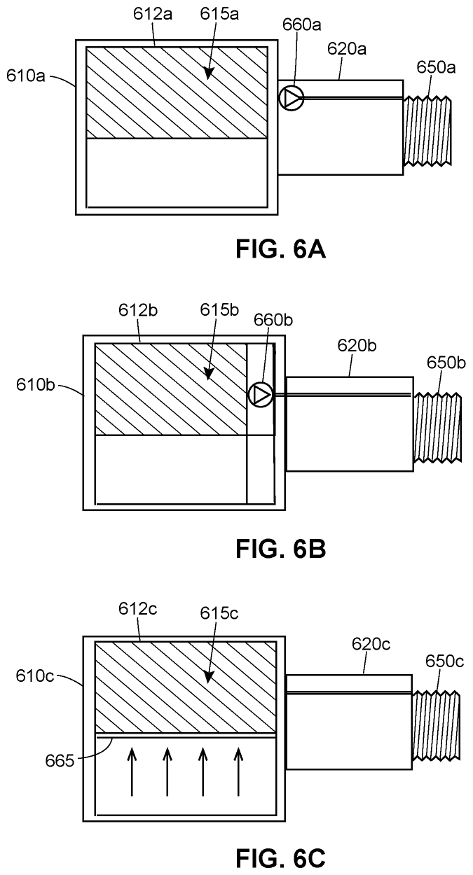

FIGS. 7A-C illustrate a system in which a tank 712 within the cavity of a payload adapter structure 710 is removable. The tank 712 may be flexible and attached to a payload 720, loaded into the cavity of the payload adapter structure 710, and filled before launch. Before deployment of the payload 720, the flexible tank 712 may be fully housed within the cavity of the payload adapter structure 710. As the payload adapter structure releases the payload, the moving payload 720 may drag the flexible tank 712 out of the cavity, as shown in FIGS. 7B and 7C, for example, via a circular opening defined by the port 725 to which the payload 720 is attached prior to deployment. To facilitate dragging out the tank 712 from the cavity, the payload 720 to which the flexible tank 712 is attached may be propelled either by its own propulsion engine, or by a propulsion engine of another payload with which the payload 725 connected to the flexible tank 712 may be docked.

FIGS. 8A-C illustrate several tethering configurations that may facilitate docking of payloads 820a-f released from ports 825a,b of a payload adapter structure 810 (e.g., the annular payload adapter structure 210 of FIG. 2A, though similar configurations may apply to the payload adapter structure 310 of FIG. 3). In FIG. 8A, a swivel hinge mechanism tether 830a may bring the docking devices 840a and 840b of the corresponding payloads 820a and 820b within a range sufficiently close for the docking devices 840a,b to engage with each other and complete the docking. For example, the docking devices 840a,b may activate electromagnets or mechanically reconfigure permanent magnets to complete the docking connection, once the swivel hinge mechanism tether 830a helps bring the docking devices close. The swivel hinge mechanism tether 830a may include one or more actuators. The actuators may be disposed at or near pivot points 832a-c of the swivel hinge mechanism tether 830a. The actuators may include motors, springs, or any other suitable devices to produce torque needed to bring the payloads 820a,b together. In some implementations, more than two payloads are docked together upon release from the payload adapter structure 810 by multiple mechanisms (e.g., including mechanism 831a) connecting pairs of payloads.

FIG. 8B illustrates payloads 820c,d connected by flexible tethers 830b,c, such as cables, ropes, wires, or any other suitable tethers. In some implementations the flexible tethers 830b,c may include elastic portions that help actuate and align the payloads 820c,d released from the ports 825a,b. Additionally or alternatively, one or more spooling mechanisms may spool the flexible tethers 830b,c to bring the payloads 820c,d close enough to complete the docking using the docking devices 840c,d. FIG. 8C illustrates an alternative flexible tether configuration to align the payloads for docking, where the docking devices 840e,f are positioned at the payload sides that are parallel to the sides attached to the payload adapter structures 825a,b prior to deployment. The tethers 830d,e may be actuated in a suitable time sequence to impart relative rotation to payloads 820e,f that ensure correct alignment. The configuration in 8C differs from the configurations in FIGS. 8A and 8B that are configured to bring together the sides of payloads 820a-d that are orthogonal to the sides attached to the payload adapter structure 810 prior to deployment. Generally, tethers may be configured to bring together any suitable payload surfaces at which docking devices are disposed. In some implementations, docking devices may be disposed at the same surfaces that attach to the payload adapter structure 810 prior to deployment.

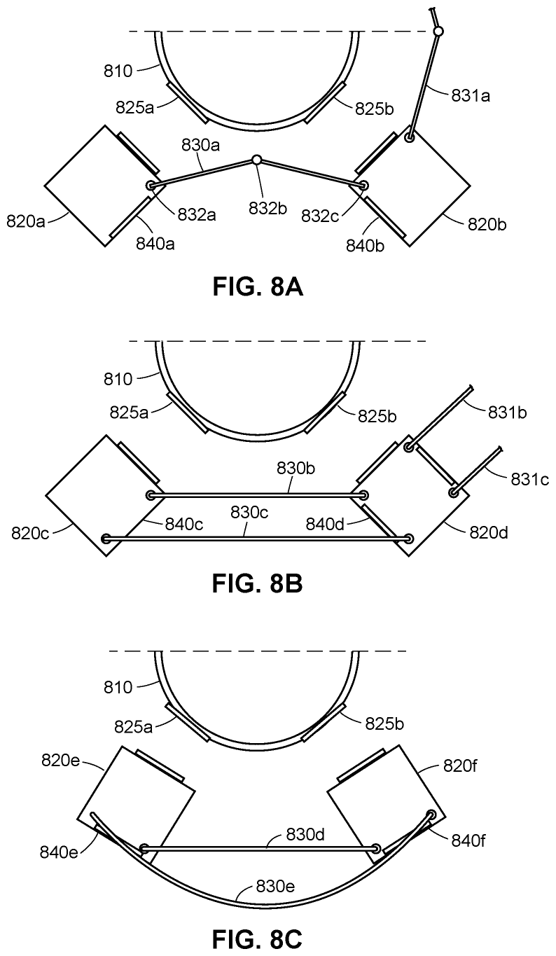

FIG. 9A illustrates a possible assembly of payloads 920 a-c just prior to docking. The swivel hinge mechanisms 930a,b may bring the payloads close enough for docking devices 940a-d to engage and complete the docking, resulting in a stack assembly of payloads 920a-c from one payload bay (e.g., payload bays 205, 305 of FIGS. 2A, 2B, 3). Payload 920c, for example, may be a transfer vehicle, configured to deliver payload 930a to a suitable orbit. To that end, the transfer vehicle (i.e., payload 920c) may include a thruster 970a. Propellant for the thruster 970b may be included in the transfer vehicle (i.e., payload 920c) or in an external tank (e.g., payload 920b, which in other implementations may be a satellite). In some implementations, the thrust generated by the transfer vehicle may cooperate with the tethering mechanisms 930a,b to bring the payload assembly together for docking.

FIG. 9B illustrates an alternative assembly of payloads deployed from a payload bay, in which four payloads 920d-g may be guided by tethers into the shown configuration and attached using the docking devices (best illustrated in FIGS. 8A-C). In one possible configuration, one payload bay payload (i.e., payload 920f) may be a transfer vehicle, one payload bay payload (i.e., payload 920e) may be a satellite to be delivered to a destination orbit (e.g., orbit 120b), and two payload bay payloads (i.e., payloads 920d,g) may be supplemental propellant tanks that may be fluidicly connected to the transfer vehicle (i.e., payload 920f) after docking facilitated by flexible tethers 930c-h.

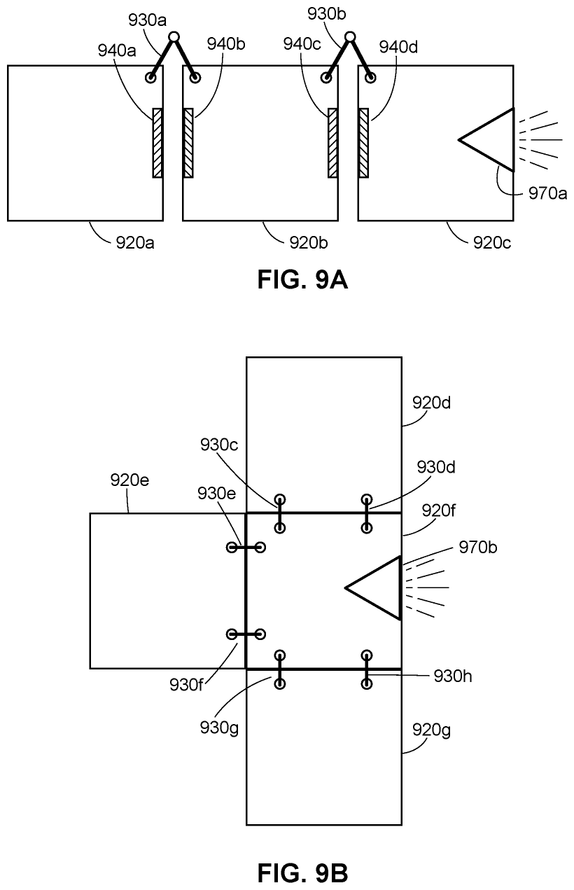

FIGS. 10A-C illustrate various configurations of guides 1012a-d that may be used to direct the movement of payloads 1020a-d attached to a payload adapter structure, such as the one illustrated in FIG. 3. Each of the FIGS. 10A-C may represent a cross-section of a payload bay transverse to the axis of the launch vehicle and/or one level or shelf of the payload adapter structure, enclosed in the corresponding fairings 1008a-c. In FIG. 10A, the guides 1012a,b are arranged in parallel straight lines. Multiple payloads (e.g., payloads 1020 a,b) may move along each guide, for example, to detach sequentially from the payload adapter structure. Additionally or alternatively, the payloads may move along the guides to distribute payload mass with respect to the launch vehicle axis. Guides in alternate layers of the payload adapter structure may be positioned in two orthogonal directions, both transverse to the axis of the launch vehicle.

FIG. 10B illustrates a radial guide configuration. Multiple payloads (e.g., payloads 120c,d) may move along each guide (e.g., guides 1012c,d) to deploy, sequentially, outward from the axis of the launch vehicle. To use the volume of the payload bay efficiently, larger payloads (e.g., payload 1020c) may attach to the guides (e.g., guides 1012c,d) closer to the fairing (e.g., fairing 1008b), while smaller payloads (e.g., payload 1020d) may attach closer to the center. Furthermore, the axial center of the payload adapter structure may include a tank of propellant that may be transferred to one or more payloads prior do deployment, analogously to the discussion above in the context of the annular payload adapter structures.

The guides need not be straight. For example, FIG. 10C illustrates a spiral guide 1012e along which all of the payloads (e.g., payloads 1020e-g) in one layer of the payload adapter structure may move to sequentially deploy, or to redistribute mass prior to launch. As with radial guides in FIG. 10B, smaller payloads (e.g., payload 1020g) may attach closer to the center of the payload bay.

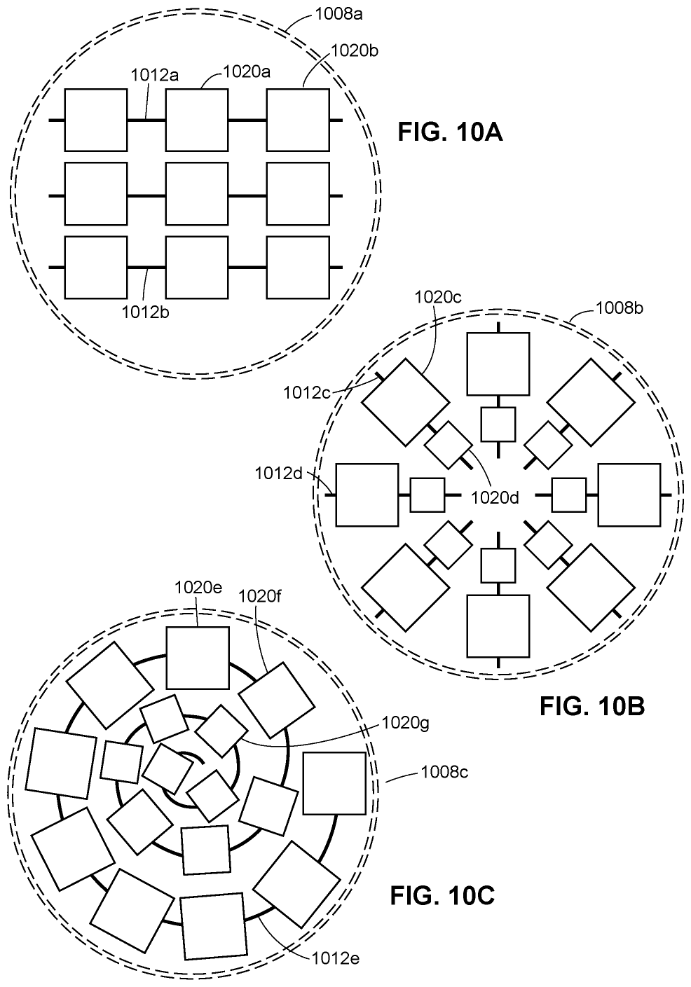

FIGS. 11A-B illustrate an application of using guides 1112a-d for distributing mass in the payload bay. For example, payload 1120c in a layer 1111a within a payload structure may have a smaller mass than the other payloads 1120a-b in the layer 1111a. Other payloads 1120d, e may move as shown with arrows to redistribute the mass in the direction of payload 1120f. To that end, payloads 1120a-f and/or the payload adapter structure may include actuators to move payloads along the guides 112a-d.

FIGS. 12A-C illustrate an implementation in which payloads 1120a-c are connected to a guide 1212 by way of carriers 1218a-c that are configured to move along the guide 1212. The carriers 1218a-c may move payloads 1220a-c to distribute the mass of the payloads, for example as in FIG. 12A. Upon reaching the deployment orbit, or at another suitable time prior to deployment, the carriers 1218a-c with attached payloads 1220a-c may move along a single guide to facilitate the docking of the payloads 1220a-c, as shown in FIG. 12B. The carriers 1218a-c may be configured to detach the payloads in parallel, as shown in FIG. 12C. The assembly of multiple payloads 1220a-c may include a transfer vehicle or another payload that may engage a thruster 1270 to complete deployment and move the assembly of payloads out and away from the payload adapter structure of the payload bay.

1-9. (canceled)

10. A system comprising:
a launch vehicle configured to deliver one or more payloads to space, the launch vehicle having an adapter structure including:
one or more walls enclosing a cavity, and
at least one port in the one or more walls;
a payload configured to couple to the launch vehicle via the at least one port of the adapter structure; and
a tank disposed within the cavity and configured to store a propellant for use by the payload.

11. The system of claim 10, wherein the payload is a transfer vehicle that uses the propellant for propulsion.

12. The system of claim 10, wherein the payload is an external tank module that stores the propellant for use by a spacecraft.

13. The system of claim 10, further comprising a pump to transfer the propellant from the tank to the payload.

14. The system of claim 11, wherein the pump is configured to transfer the propellant from the tank to the payload when the launch vehicle reaches an orbit at which the payload separates from the launch vehicle.

15. The system of claim 11, wherein the pump is disposed inside the payload.

16. The system of claim 11, wherein the tank is permanently mounted inside the cavity.

17. The system of claim 10, wherein the tank is collapsible; the adapter structure further including:
an actuator configured to move a piston to cause the propellant to flow from the tank to the payload.

18. The system of claim 17, wherein the actuator is configured to transfer the propellant from the tank to the payload when the launch vehicle reaches an initial orbit at which the payload separates from the launch vehicle.

19. The system of claim 10, wherein the system is configured to extract the tank out of the cavity of the adapter structure when the launch vehicle reaches an orbit at which the payload separates from the launch vehicle.

20. The system of claim 19, wherein the tank is elastic.

21. The system of claim 19, wherein:
the at least one port defines a circular opening in the one or more walls; and
the system is configured to extract the tank via the at least one port.

22. The system of claim 10, wherein the adapter structure conforms to a format of an evolved expendable launch vehicle (EELV) secondary payload adapter (ESPA).

23. An adapter structure for coupling at least one transfer vehicle to a launch vehicle that delivers the transfer vehicle to space, the adapter structure comprising:
one or more walls enclosing a cavity; and
at least one port to removeably receive the transfer vehicle and release the transfer vehicle when the launch vehicle reaches an initial orbit; and
a tank disposed inside the cavity and configured to store a propellant for use by the transfer vehicle.

24. The adapter structure of claim 23, wherein the tank is accessible to the transfer vehicle via the at least one port.

25. A method for providing propellant in space, the method comprising:
providing an adapter structure for removeably coupling a payload to a launch vehicle, wherein the payload detaches from the launch vehicle upon reaching an initial orbit, and wherein the adapter structure includes (i) at least one port in one or more walls enclosing a cavity, via which the payload removeably couples to the adapter structure, and (ii) a tank disposed inside the cavity;
providing a propellant inside the tank;
causing the adapter structure to separate from the launch vehicle subsequently to the payload detaching from the launch vehicle, to enter a certain orbit; and
providing access to the tank to a spacecraft that docks with the adapter structure at the certain orbit.

26-34. (canceled)

35. The method of claim 25, further comprising:
providing a pump to transfer the propellant from the tank to the spacecraft.

36. The method of claim 25, wherein the tank is collapsible; the method further comprising:
providing, with the adapter structure, an actuator configured to move a piston to cause the propellant to flow from the tank to the payload.

37. The method of claim 25, wherein the tank is elastic.

38. The method of claim 25, wherein the adapter structure conforms to a format of an evolved expendable launch vehicle (EELV) secondary payload adapter (ESPA).
